(19) United States
(12) Patent Application Publication
(10) Pub. No.: US 2008/0143218 A1
(43) Pub. Date: Jun. 19, 2008

(54) ENCLOSURE SYSTEM FOR ELECTRONIC EQUIPMENT CONCEALABLE IN A TABLE TOP

(76) Inventor: Sergey Alayev, Fullerton, CA (US)

Correspondence Address: VLADIMIR KHITERER;KHITERER LAW OFFICE, 2109 W. COAST HWY., SUITE 200, NEWPORT BEACH, CA, 92663, US

(21) Appl. No.: 11/611,295

(22) Filed: Dec. 15, 2006

(51) Int. Cl. A61G 11/00

(52) U.S. Cl. 312/1

(57) ABSTRACT

An enclosure system for electronic equipment concealable in a table top is disclosed. The enclosure system has a saddle attached to a bezel. The saddle defines an open area for receiving an enclosure. The bezel defines an opening for receiving a top plate of the enclosure. An outer perimeter of the bottom surface of the bezel rests on edges of an opening cut through a table top. The enclosure pivots from a concealed position, in which the top plate is flush with the bezel, to an open position in which the face plate of the enclosure is exposed. A spring made out of tempered carbon steel plate biases the enclosure towards the open position, while a latch maintains the enclosure in the concealed position.

### BACKGROUND OF THE INVENTION

This invention pertains to an enclosure system for electronic equipment, such as interconnect equipment for audio/visual presentation systems, concealable in a table top. The central element of many audio/visual presentation systems is some sort of table or countertop. The challenge that faces the system designer is how to provide an input plate in the table for computer video, video, audio, network, and AC power connections without making an obstruction that gets in the way when it isn't needed.

Enclosure systems housing such input plates and other equipment that can be concealed in the table top when not in use offer improved user-friendliness, aesthetic design, and flexibility. To work properly, such enclosure systems must endure constant openings and closings without losing quality and smooth feel of operation. The prior art enclosures of this type, notably the U.S. Pat. No. 6,802,577, utilize a hydraulic spring to bias the enclosure in the open position. However, when transported by air, due to changes in pressure at high altitudes, hydraulic springs are prone to leakage.

As such, there is need for an alternative to hydraulic springs to bias the enclosure in the open position, which is inexpensive and can withstand constant openings and closings over the lifespan of the enclosure system.

### SUMMARY OF THE INVENTION

The enclosure system for electronic equipment concealable in a table top of the present invention satisfies this need. It comprises a saddle with a base and two vertical legs on the opposite sides of the base attached to a bezel at the upper ends of the legs. The legs and the base define an open area for receiving an enclosure. The bezel defines an opening for receiving a top plate of the enclosure. An outer perimeter of the bottom surface of the bezel rests on edges of an opening cut through a table top.

The enclosure can be selectively pivotally moved from a concealed position in which the top plate is flush with the bezel to an open position in which the face plate of the enclosure is exposed. A plate made out of tempered carbon steel biases the enclosure towards the open position, while a latch selectively maintains the enclosure in the concealed position.

### BRIEF DESCRIPTION OF THE DRAWINGS FIGURES

FIG. 1 shows exploded isometric view of the enclosure system according to the first preferred embodiments of the present invention.

FIG. 2 shows side elevational view of the enclosure system according to the first preferred embodiment of the present invention in the concealed position.

FIG. 3 shows side elevational view of the enclosure system according to the first preferred embodiment of is the present invention in the open position.

FIG. 4 shows exploded isometric view of the enclosure system according to the second preferred embodiments of the present invention.

FIG. 5 shows exploded isometric view of the enclosure system according to the third preferred embodiments of the present invention.

FIG. 6 shows side elevational view of the enclosure system according to the third preferred embodiment of the present invention in the concealed position.

FIG. 7 shows side elevational view of the enclosure system according to the third preferred embodiment of the present invention in the open position.

FIG. 8 shows exploded isometric view of the enclosure system according to the fourth preferred embodiments of the present invention.

FIG. 9 shows side elevational view of the enclosure system according to the fourth preferred embodiment of the present invention in the concealed position.

FIG. 10 shows side elevational view of the enclosure system according to the fourth preferred embodiment of the present invention in the open position.

FIG. 11 shows exploded isometric view of the enclosure system according to the fifth preferred embodiments of the present invention.

FIG. 12 shows side elevational view of the enclosure system according to the fifth preferred embodiment of the present invention in the concealed position.

FIG. 13 shows side elevational view of the enclosure system according to the fifth preferred embodiment of the present invention in the open position.

FIG. 14 shows front elevational view of the enclosure system according to the fifth preferred embodiment of the present invention in the open position.

FIG. 15 shows exploded isometric view of the enclosure system according to the sixth preferred embodiments of the present invention.

FIG. 16 shows front elevational view of the enclosure system according to the sixth preferred embodiment of the present invention in the open position.

### DETAILED DESCRIPTION OF THE PREFERRED EMBODIMENTS

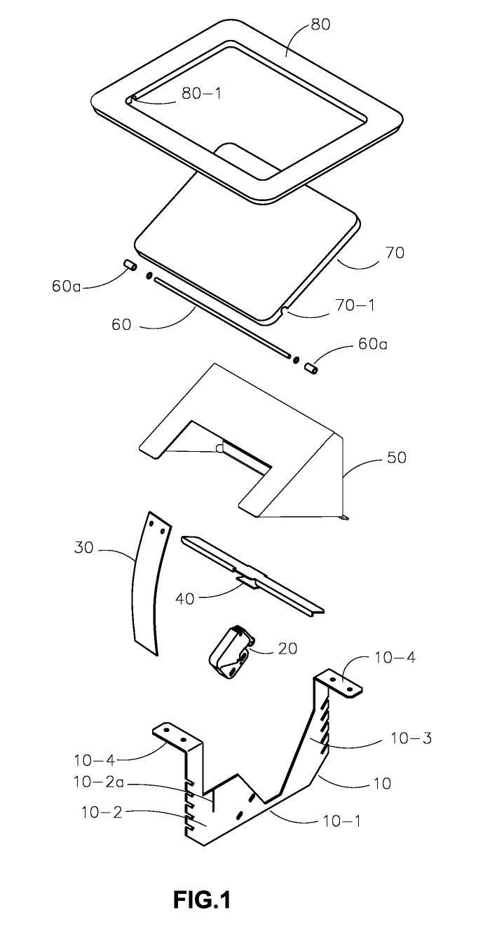

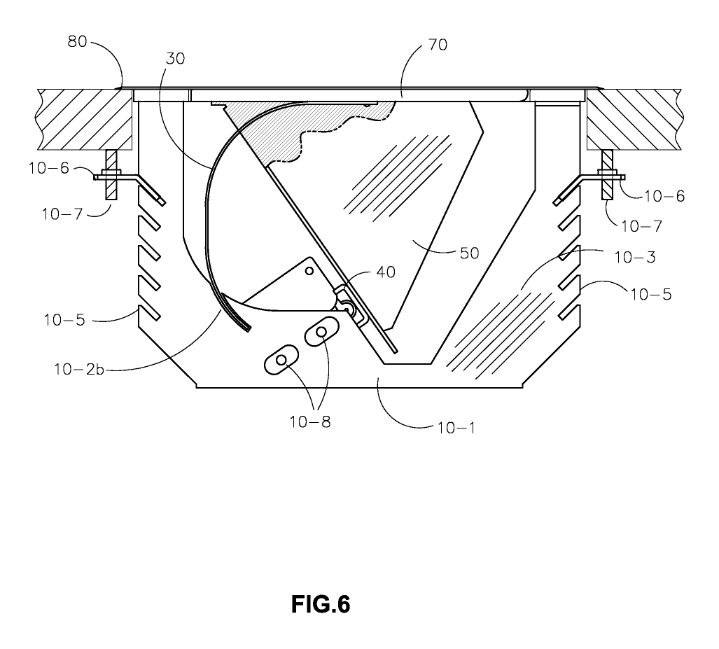

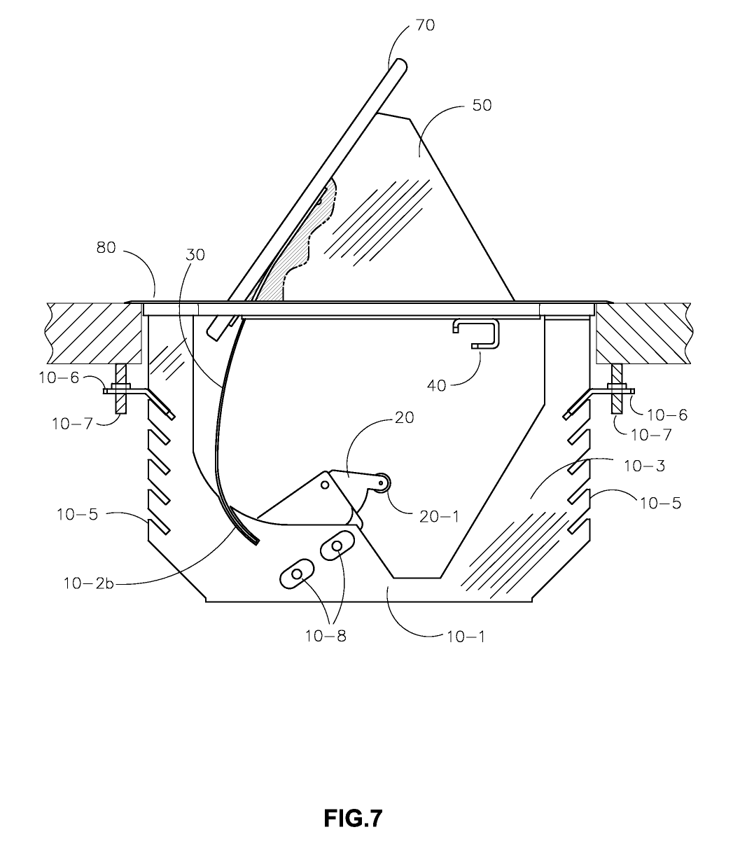

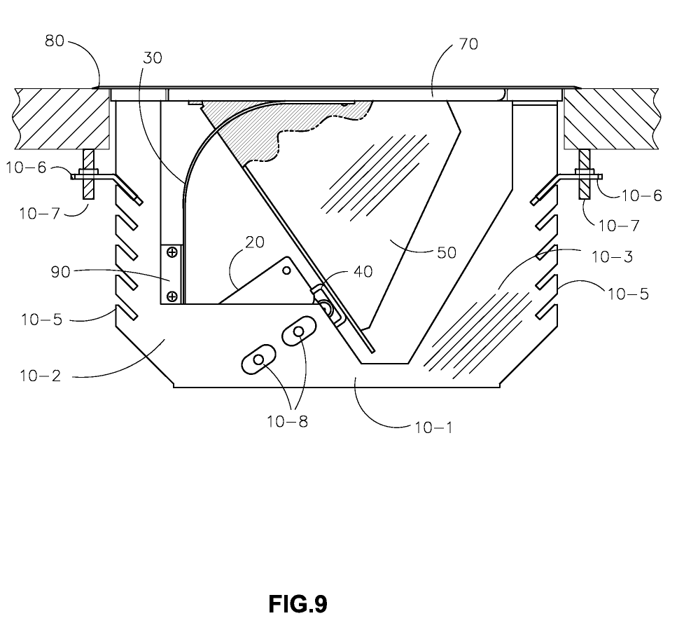

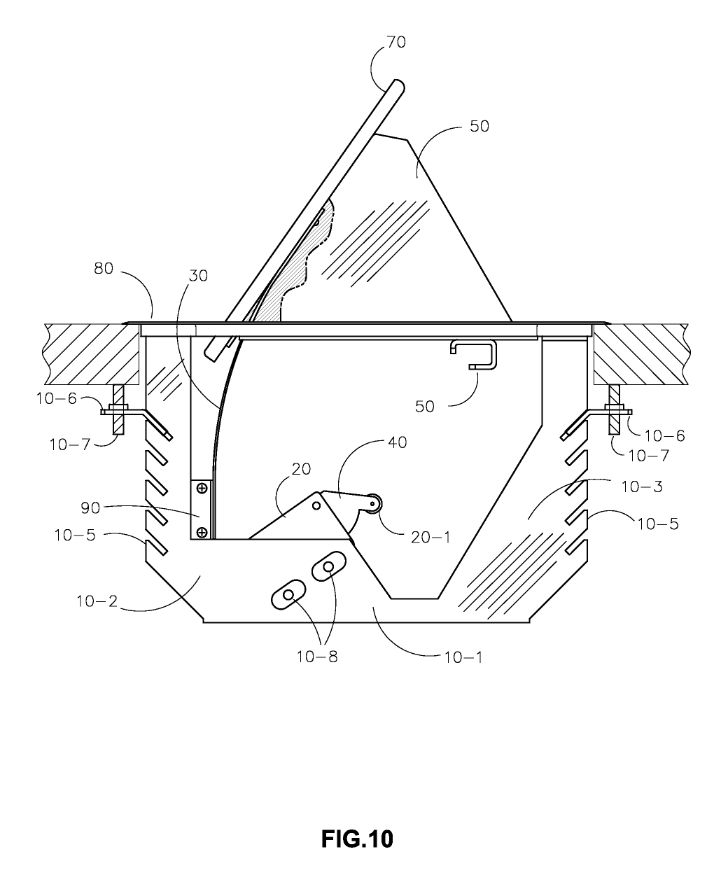

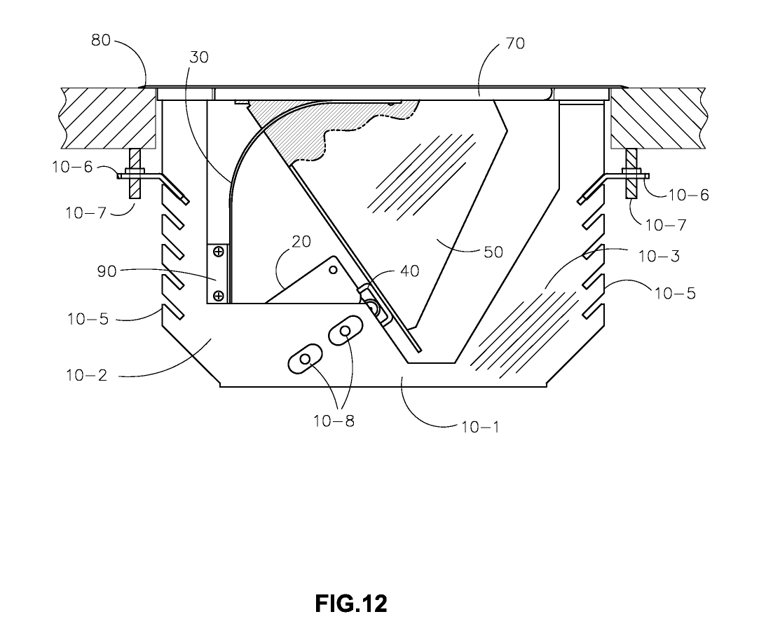

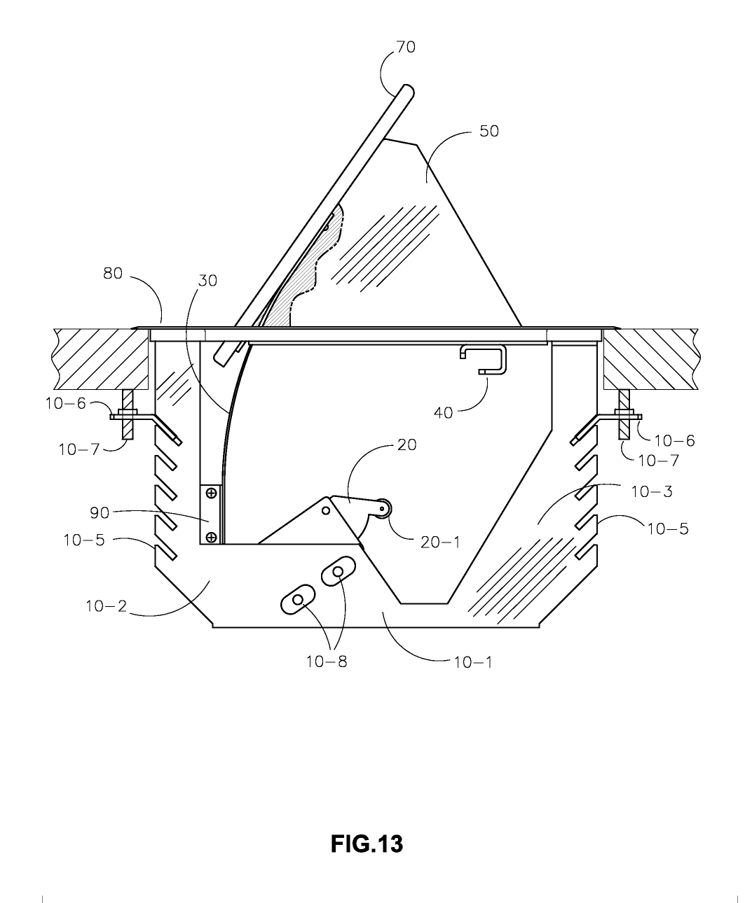

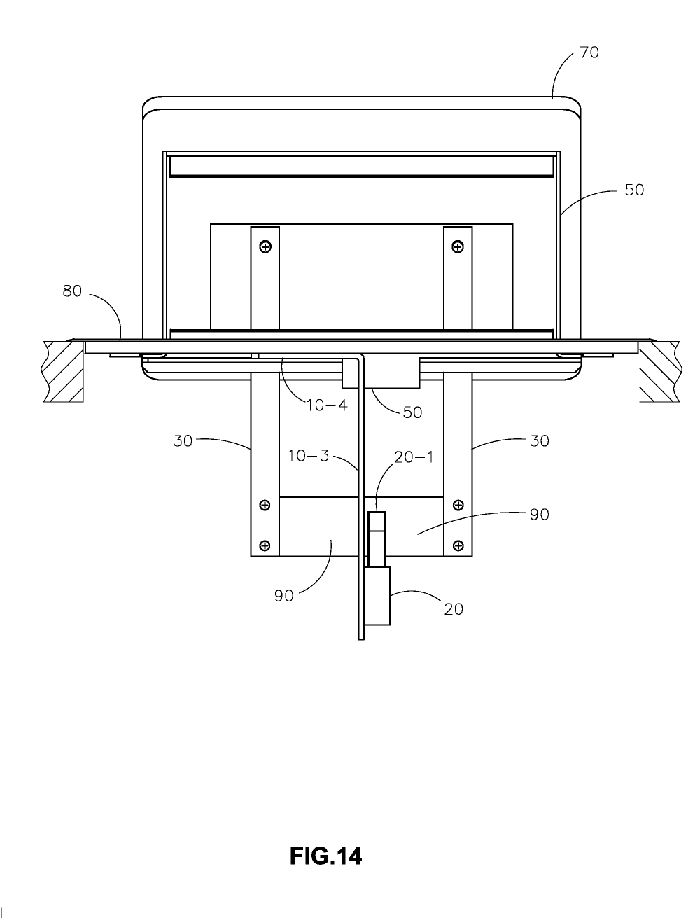

This invention will be better understood with the reference to the drawing figures FIG. 1 through FIG. 16. The same numerals refer to the same elements in all drawing figures.

Viewing FIG. 1, numeral 10 indicates a saddle. Saddle 10 comprises a base member indicated by numeral 10-1, a first vertical leg indicated by numeral 10-2 and a second vertical leg indicated by numeral 10-3. First Vertical Leg 10-2 extends up from one end of Base Member 10-1 and terminates in a first upper end. Second Vertical Leg 10-2 extends up from an opposite end of Base Member 10-1 and terminates in a second upper end.

Numeral 10-4 indicates attachment means disposed on the first upper end and the second upper end.

Still viewing FIG. 1, numeral 20 indicates a latch means. Numeral 30 indicates a spring means. Numeral 40 indicates a catch means. Numeral 50 indicates an enclosure. Enclosure 50 is suitable for housing electronic equipment and comprises a face plate, a top portion, two opposite side walls and a bottom portion.

Still viewing FIG. 1, numeral 60 indicates a hinge means. Numeral 70 indicates a top plate. Numeral 80 indicates a bezel. Bezel 80 comprises a top surface and a bottom surface and defines an opening for receiving Top Plate 70. An outer perimeter of the bottom surface of Bezel 80 is for resting on edges of an opening cut through a table top (the table top is not shown in FIG. 1). Numerals 70-1 and 80-1 indicate bores for receiving Hinge Means 60.

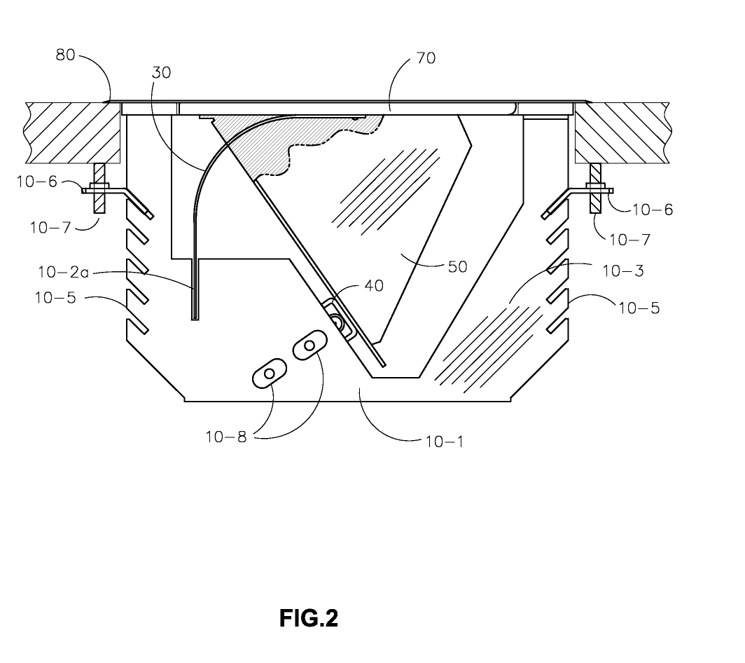

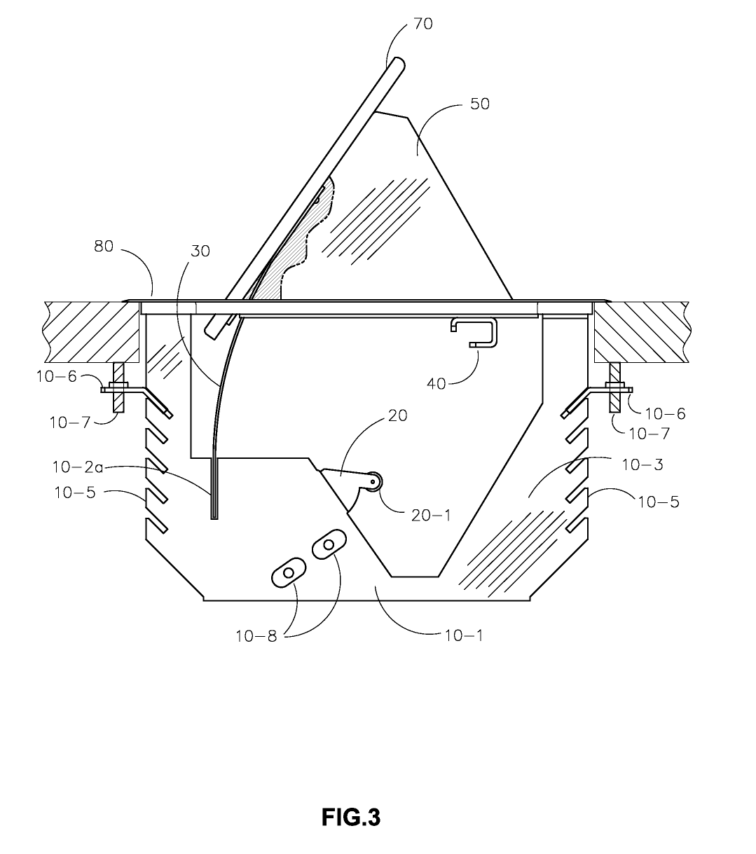

Viewing now FIG. 2 and FIG. 3, Saddle 10 is fixedly attached to the bottom surface of Bezel 80 by way of Attachment Means 10-4. Top Plate 70 is fixedly attached to the top portion of Enclosure 50.

First Vertical Leg 10-2, Second Vertical Leg 10-3 and Base Member 10-1 together define an open area for receiving Enclosure 50 therein. Numeral 10-2a indicates an open slot disposed in First Vertical Leg 10-2. Open Slot 10-2a extends downwardly from the open area.

Top Plate 70 is pivotally mounted to Bezel 80 by way of Hinge Means 60 received in Bores 70-1 and 80-1 for pivotal movement of Enclosure 50 from a concealed position in which Top Plate 70 is flush with Bezel 80 (shown in FIG. 2) to an open position in which the face plate of Enclosure 50 is exposed (shown in FIG. 3).

Still viewing FIG. 2 and FIG. 3, Latch Means 20 is fixedly attached to First Vertical Leg 10-2, Catch Means 40 is fixedly attached to the bottom portion of Enclosure 50 such that Latch Means 20 selectively maintains Enclosure 50 in the concealed position by way of engaging with Catch Means 40. Specifically, Catch Means 40 is shown in FIG. 1 through FIG. 3 as a hook. Latch Means 20 comprises a spring loaded roller indicated by numeral 20-1. Spring Loaded Roller 20-1 is for engaging with the hook of Catch Means 40.

Still viewing FIG. 2 and FIG. 2, Spring Means 30 is a substantially rectangular elongated plate made out of tempered carbon steel. Spring Means 30 comprises a free proximal end inserted into Open Slot 10-2a and a distal end fixedly attached to Enclosure 50, thereby biasing Enclosure 50 towards the open position.

To launch Enclosure 50 in the open position, one would push on Top Plate 70 causing Spring Loaded Roller 20-1 to disengage with the hook of Catch Means 40. This will cause Spring Means 30 to push Enclosure 50 up. To conceal Enclosure 50, one would push on Top Plate 70 until Spring Loaded Roller 20-1 engages with the hook of Catch Means 40.

Still viewing FIG. 2 and FIG. 3, Saddle 10 further comprises a plurality of teeth indicated by numeral 10-5. Teeth 10-5 are disposed along outer edges of First Vertical Leg 10-2 and Second Vertical Leg 10-3. Teeth 10-5 extend upwardly at a substantially forty five degree angle in relation to the outer edges of First Vertical Leg 10-2 and Second Vertical Leg 10-3 and define spaces therebetween for effecting insertion of holding plates indicated by numeral 10-6. Holding Plates 10-6 are formed from strips of bent sheet metal and comprise openings for receiving lag screws indicated by numeral 10-7. Lag Screws 10-7 are for biasing Holding Plates 10-6 inserted in said spaces in the direction opposite to a bottom of the table top, thereby securing Saddle 10 to the tabletop (the table top with an opening for receiving the enclosure system of this invention is shown in FIG. 2 and FIG. 3).

Viewing now FIG. 2 and FIG. 3, First Vertical Leg 10-2 further comprises two elongated openings indicated by numeral 10-8. Elongated Openings 10-8 are for receiving screws for attaching Latch Means 20 to First Vertical Leg 10-2 such that the position of Latch Means 20 can be adjusted prior to fixedly attaching Latch Means 20 to First Vertical Leg 10-2 by way of said screws. Such adjustment allows to ensure that when Enclosure 50 is in the concealed position (i.e. Spring Loaded Roller 20-1 is engaged with the hook of Catch Means 40), Top Plate 70 is flush with Bezel 80.

Further, Saddle 10 and Latch Means 20 are shown in FIG. 1 through FIG. 3 as formed from bent sheet metal. However, Saddle 10 and/or Latch Means 20 can be also formed from machined metal, cast metal, bent wire or plastic.

Viewing again FIG. 1, Hinge Means 60 further comprises dampening means indicated by numeral 60a. Dampening Means 60a prevents abrupt movement of Enclosure 50 to the open position.

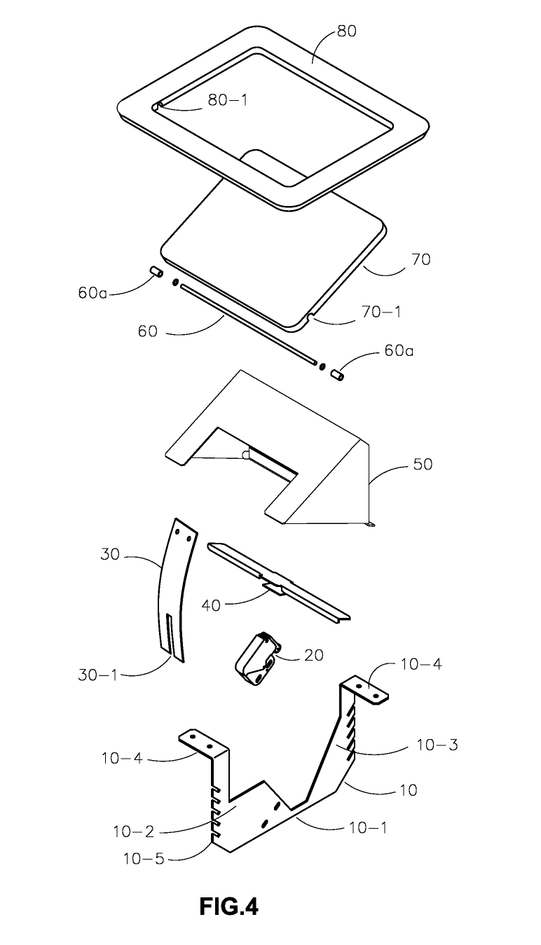

Viewing now FIG. 4, the second preferred embodiment of this invention differs from that described in reference to FIG. 1 through FIG. 3 in that Open Slot 10-2a is not present in First Vertical Leg 10-2. Rather, Spring Means 30 comprises a free fork shaped proximal end indicated by numeral 30-1. Fork Shaped Proximal End 30-1 is disposed over Saddle 10. During operation, Fork Shaped Proximal End 30-1 slides over Saddle 10 and prevents lateral movement of Spring Means 30.

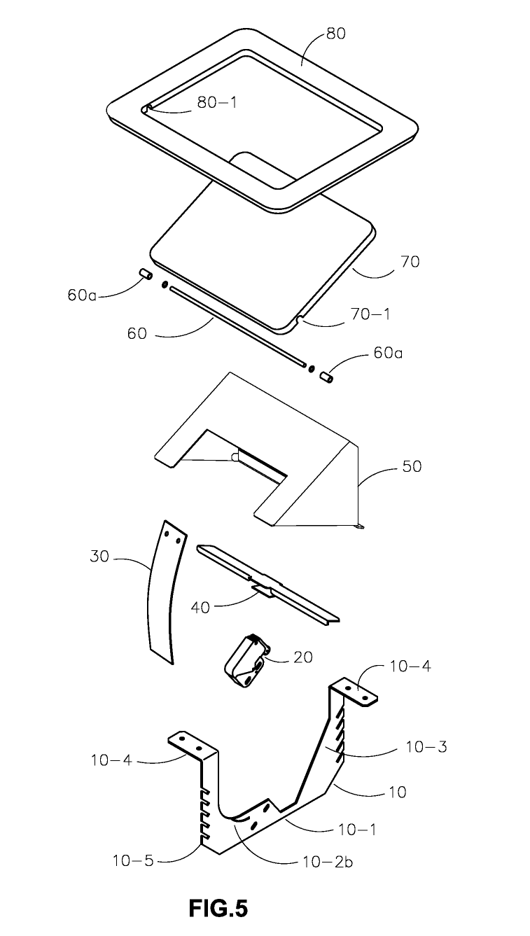

Viewing now FIG. 5 through FIG. 7, the third preferred embodiment of this invention differs from that described in reference to FIG. 1 through FIG. 3 in that Open Slot 10-2a is not present in First Vertical Leg 10-2. Rather, there is provided an open curved slot indicated by numeral 10-2b. During operation, the free proximal end of Spring Means 30 slides within Open Curved Slot 10-2b, which provides an additional anti-dampening effect.

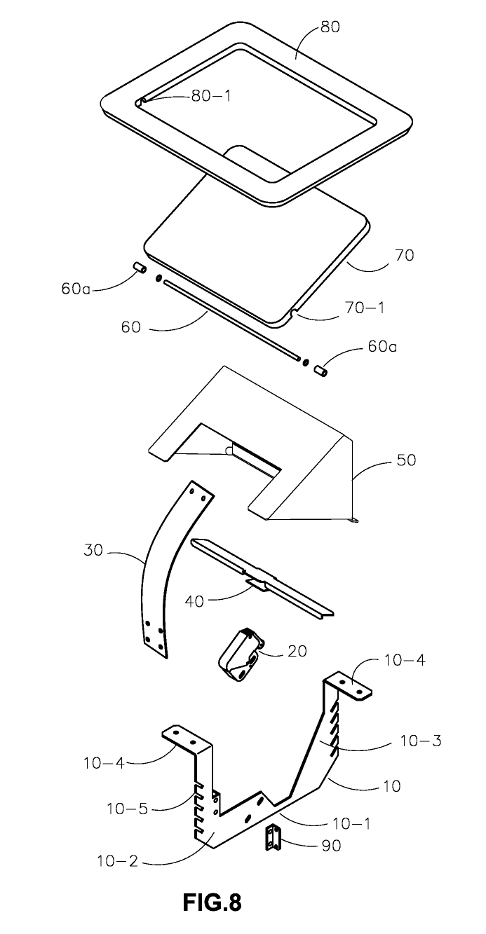

Viewing now FIG. 8 through FIG. 10, in the fourth preferred embodiment of this invention Spring Means 30 comprises a proximal end fixedly attached to Saddle 10 and a distal end fixedly attached to Enclosure 50. In FIG. 8 through FIG. 10, the proximal end of Spring Means 30 is shown to be attached by bolts to L-shaped brackets indicated by numeral 90. L-shaped Brackets 90 are shown to be bolted to First Vertical Leg 10-2. However, the proximal end of Spring Means 30 may be fixedly attached by any means known to the persons knowledgeable in the pertinent arts, including welding. Further, said attachment can be located in any convenient spot on Saddle 10, not necessarily First Vertical Leg 10-2.

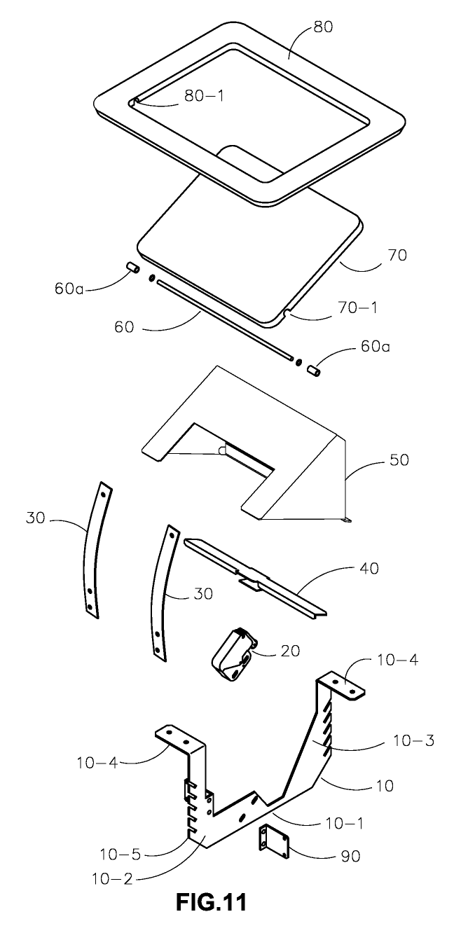

Viewing now FIG. 11 through FIG. 14, in the fifth preferred embodiment of this invention a plurality of Spring Means 30 is used. Each of Spring Means 30 comprises a proximal end fixedly attached to Saddle 10 and a distal end fixedly attached to Enclosure 50.

Two Spring Means 30 are shown in FIG. 11 through FIG. 14, however, the number of Spring Means 30 is limited only by space considerations. The benefit of using more than one Spring Means 30 is that it provides smoother operation, which has been discovered through experiments.

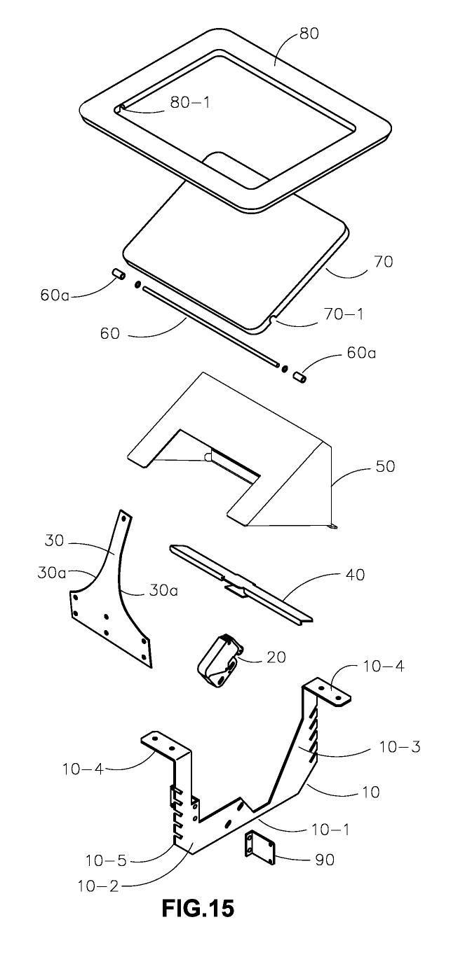

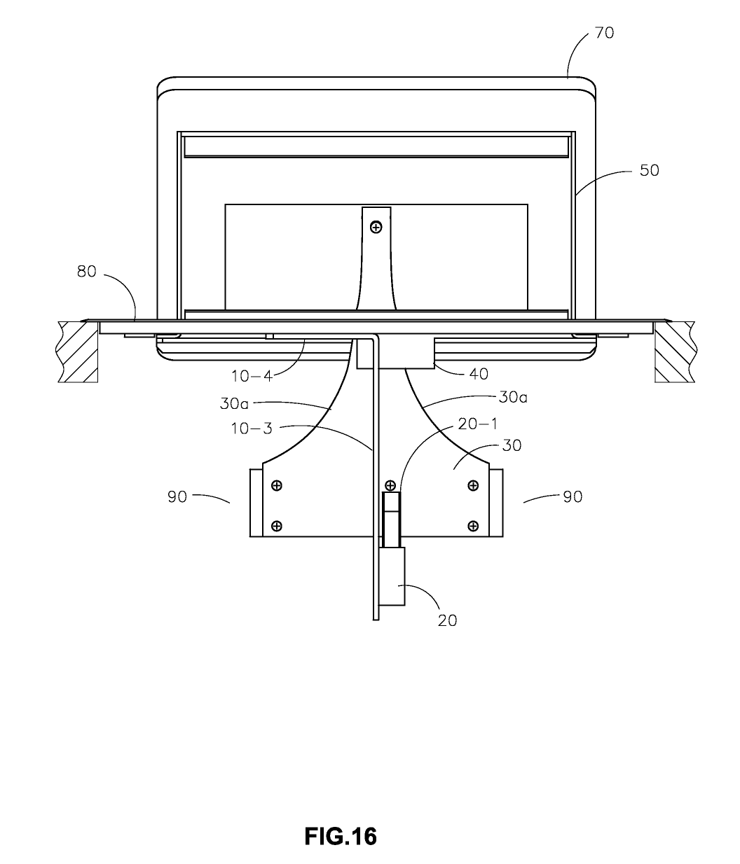

Viewing now FIG. 15 and FIG. 16, in the sixth preferred embodiment of this invention, Spring Means 30 comprises a proximal end fixedly attached to Saddle 10 and a distal end fixedly attached to Enclosure 50, as well as sides indicated by numeral 30a tapered toward one another in the direction toward the distal end. The distribution of forces along Spring Means 30 due to this tapering provides smoother operation.

While the present invention has been described and defined by reference to the preferred embodiment of the invention, such reference does not imply a limitation on the invention, and no such limitation is to be inferred. The invention is capable of considerable modification, alteration, and equivalents in form and function, as will occur to those ordinarily skilled and knowledgeable in the pertinent arts. The depicted and described preferred embodiment of the invention is exemplary only, and is not exhaustive of the scope of the invention. Consequently, the invention is intended to be limited only by the spirit and scope of the appended claims, giving full cognizance to equivalents in all respects.

What is claimed is:

1. An enclosure system for electronic equipment concealable in a table top comprising:
(1) a saddle;
(2) a latch means;
(3) a spring means;
(4) a catch means;
(5) an enclosure suitable for housing electronic equipment and comprising a face plate, a top portion, two opposite side walls and a bottom portion;
(6) a top plate fixedly attached to the top portion of the enclosure;
(7) a bezel comprising a top surface and a bottom surface, the bezel defining an opening for receiving the top plate, wherein an outer perimeter of the bottom surface is for resting on edges of an opening cut through a table top;
(8) a hinge means;
wherein the saddle comprises:
a base member;
a first vertical leg extending up from one end of the base member and terminating in a first upper end;
a second vertical leg extending up from an opposite end of the base member and terminating in a second upper end, the first and second vertical legs and the base member together defining an open area for receiving the enclosure therein;
attachment means disposed on the first upper end and the second upper end fixedly attaching the saddle to the bottom surface of the bezel;
an open slot disposed in the first vertical leg extending downwardly from the open area;
wherein the top plate is pivotally mounted to the bezel by way of the hinge means for pivotal movement of the enclosure from a concealed position in which the top plate is flush with the bezel to an open position in which the face plate is exposed;
wherein the latch means is fixedly attached to the first vertical leg and the catch means is fixedly attached to the bottom portion of the enclosure such that the latch means selectively maintains the enclosure in the concealed position by way of engaging with the catch means;
wherein the spring means is a substantially rectangular elongated plate made out of tempered carbon steel comprising a free proximal end inserted into the open slot and a distal end fixedly attached to the enclosure, biasing the enclosure towards the open position.

2. An enclosure system as in claim 1, wherein the hinge means further comprises dampening means preventing abrupt movement of the enclosure to the open position.

3. An enclosure system as in claim 2, wherein the saddle is formed from the material selected from the group consisting of bent sheet metal, machined metal, cast metal, bent wire and plastic.

4. An enclosure system as in claim 3, wherein the saddle further comprises a plurality of teeth disposed along outer edges of the first and second vertical legs, the teeth extending upwardly at a substantially forty five degree angle in relation to the outer edges and defining spaces therebetween for effecting insertion of holding plates, said holding plates being formed from strips of bent sheet metal and comprising openings for receiving lag screws for biasing the holding plates inserted in said spaces in the direction opposite to a bottom of the table top, thereby securing the saddle to the tabletop.

5. An enclosure system as in claim 4, wherein the catch means is a hook formed from the material selected from the group consisting of bent sheet metal, machined metal, cast metal, bent wire and plastic and wherein the latch means further comprises a spring loaded roller for engaging with the hook.

6. An enclosure system as in claim 5, wherein the first vertical leg further comprises a plurality of elongated openings for receiving screws for attaching the latch means to the first vertical leg such that the position of the latch means can be adjusted prior to fixedly attaching the latch means to the first vertical leg by way of said screws.

7. An enclosure system for electronic equipment concealable in a table top comprising:
(1) a saddle;
(2) a latch means;
(3) a spring means;
(4) a catch means;
(5) an enclosure suitable for housing electronic equipment and comprising a face plate, a top portion, two opposite side walls and a bottom portion;
(6) a top plate fixedly attached to the top portion of the enclosure;
(7) a bezel comprising a top surface and a bottom surface, the bezel defining an opening for receiving the top plate, wherein an outer perimeter of the bottom surface is for resting on edges of an opening cut through a table top;
(8) a hinge means;
wherein the saddle comprises:
a base member;
a first vertical leg extending up from one end of the base member and terminating in a first upper end;
a second vertical leg extending up from an opposite end of the base member and terminating in a second upper end, the first and second vertical legs and the base member together defining an open area for receiving the enclosure therein;
attachment means disposed on the first upper end and the second upper end fixedly attaching the saddle to the bottom surface of the bezel;
wherein the top plate is pivotally mounted to the bezel by way of the hinge means for pivotal movement of the enclosure from a concealed position in which the top plate is flush with the bezel to an open position in which the face plate is exposed;
wherein the latch means is fixedly attached to the first vertical leg and the catch means is fixedly attached to the bottom portion of the enclosure such that the latch means selectively maintains the enclosure in the concealed position by way of engaging with the catch means;
wherein the spring means is a substantially rectangular elongated plate made out of tempered carbon steel comprising a free fork shaped proximal end disposed over the saddle and a distal end fixedly attached to the enclosure, biasing the enclosure towards the open position.

8. An enclosure system as in claim 7, wherein the hinge means further comprises dampening means preventing abrupt movement of the enclosure to the open position.

9. An enclosure system as in claim 8, wherein the saddle is formed from the material selected from the group consisting of bent sheet metal, machined metal, cast metal, bent wire and plastic.

10. An enclosure system as in claim 9, wherein the saddle further comprises a plurality of teeth disposed along outer edges of the first and second vertical legs, the teeth extending upwardly at a substantially forty five degree angle in relation to the outer edges and defining spaces therebetween for effecting insertion of holding plates, said holding plates being formed from strips of bent sheet metal and comprising openings for receiving lag screws for biasing the holding plates inserted in said spaces in the direction opposite to a bottom of the table top, thereby securing the saddle to the tabletop.

11. An enclosure system as in claim 10, wherein the catch means is a hook formed from the material selected from the group consisting of bent sheet metal, machined metal, cast metal, bent wire and plastic and wherein the latch means further comprises a spring loaded roller for engaging with the hook.

12. An enclosure system as in claim 11, wherein the first vertical leg further comprises a plurality of elongated openings for receiving screws for attaching the latch means to the first vertical leg such that the position of the latch means can be adjusted prior to fixedly attaching the latch means to the first vertical leg by way of said screws.

13. An enclosure system for electronic equipment concealable in a table top comprising:
(1) a saddle;
(2) a latch means;
(3) a spring means;
(4) a catch means;
(5) an enclosure suitable for housing electronic equipment and comprising a face plate, a top portion, two opposite side walls and a bottom portion;
(6) a top plate fixedly attached to the top portion of the enclosure;
(7) a bezel comprising a top surface and a bottom surface, the bezel defining an opening for receiving the top plate, wherein an outer perimeter of the bottom surface is for resting on edges of an opening cut through a table top;
(8) a hinge means;
wherein the saddle comprises:
a base member;
a first vertical leg extending up from one end of the base member and terminating in a first upper end;
a second vertical leg extending up from an opposite end of the base member and terminating in a second upper end, the first and second vertical legs and the base member together defining an open area for receiving the enclosure therein;
attachment means disposed on the first upper end and the second upper end fixedly attaching the saddle to the bottom surface of the bezel;
an open curved slot disposed in the first vertical leg extending from the open area;
wherein the top plate is pivotally mounted to the bezel by way of the hinge means for pivotal movement of the enclosure from a concealed position in which the top plate is flush with the bezel to an open position in which the face plate is exposed;
wherein the latch means is fixedly attached to the first vertical leg and the catch means is fixedly attached to the bottom portion of the enclosure such that the latch means selectively maintains the enclosure in the concealed position by way of engaging with the catch means;
wherein the spring means is a substantially rectangular elongated plate made out of tempered carbon steel comprising a free proximal end inserted into the open curved slot and a distal end fixedly attached to the enclosure, biasing the enclosure towards the open position.

14. An enclosure system as in claim 13, wherein the hinge means further comprises dampening means preventing abrupt movement of the enclosure to the open position.

15. An enclosure system as in claim 14, wherein the saddle is formed from the material selected from the group consisting of bent sheet metal, machined metal, cast metal, bent wire and plastic.

16. An enclosure system as in claim 15, wherein the saddle further comprises a plurality of teeth disposed along outer edges of the first and second vertical legs, the teeth extending upwardly at a substantially forty five degree angle in relation to the outer edges and defining spaces therebetween for effecting insertion of holding plates, said holding plates being formed from strips of bent sheet metal and comprising openings for receiving lag screws for biasing the holding plates inserted in said spaces in the direction opposite to a bottom of the table top, thereby securing the saddle to the tabletop.

17. An enclosure system as in claim 16, wherein the catch means is a hook formed from the material selected from the group consisting of bent sheet metal, machined metal, cast metal, bent wire and plastic and wherein the latch means further comprises a spring loaded roller for engaging with the hook.

18. An enclosure system as in claim 17, wherein the first vertical leg further comprises a plurality of elongated openings for receiving screws for attaching the latch means to the first vertical leg such that the position of the latch means can be adjusted prior to fixedly attaching the latch means to the first vertical leg by way of said screws.

19. An enclosure system for electronic equipment concealable in a table top comprising:
(1) a saddle;
(2) a latch means;
(3) a spring means;
(4) a catch means;
(5) an enclosure suitable for housing electronic equipment and comprising a face plate, a top portion, two opposite side walls and a bottom portion;
(6) a top plate fixedly attached to the top portion of the enclosure;
(7) a bezel comprising a top surface and a bottom surface, the bezel defining an opening for receiving the top plate, wherein an outer perimeter of the bottom surface is for resting on edges of an opening cut through a table top;
(8) a hinge means;
wherein the saddle comprises:
a base member;
a first vertical leg extending up from one end of the base member and terminating in a first upper end;
a second vertical leg extending up from an opposite end of the base member and terminating in a second upper end, the first and second vertical legs and the base member together defining an open area for receiving the enclosure therein;
attachment means disposed on the first upper end and the second upper end fixedly attaching the saddle to the bottom surface of the bezel;
wherein the top plate is pivotally mounted to the bezel by way of the hinge means for pivotal movement of the enclosure from a concealed position in which the top plate is flush with the bezel to an open position in which the face plate is exposed;
wherein the latch means is fixedly attached to the first vertical leg and the catch means is fixedly attached to the bottom portion of the enclosure such that the latch means selectively maintains the enclosure in the concealed position by way of engaging with the catch means;
wherein the spring means is a substantially rectangular elongated plate made out of tempered carbon steel comprising a proximal end fixedly attached to the saddle and a distal end fixedly attached to the enclosure, biasing the enclosure towards the open position.

20. An enclosure system as in claim 19, wherein the hinge means further comprises dampening means preventing abrupt movement of the enclosure to the open position.

21. An enclosure system as in claim 20, wherein the saddle is formed from the material selected from the group consisting of bent sheet metal, machined metal, cast metal, bent wire and plastic.

22. An enclosure system as in claim 21, wherein the saddle further comprises a plurality of teeth disposed along outer edges of the first and second vertical legs, the teeth extending upwardly at a substantially forty five degree angle in relation to the outer edges and defining spaces therebetween for effecting insertion of holding plates, said holding plates being formed from strips of bent sheet metal and comprising openings for receiving lag screws for biasing the holding plates inserted in said spaces in the direction opposite to a bottom of the table top, thereby securing the saddle to the tabletop.

23. An enclosure system as in claim 22, wherein the catch means is a hook formed from the material selected from the group consisting of bent sheet metal, machined metal, cast metal, bent wire and plastic and wherein the latch means further comprises a spring loaded roller for engaging with the hook.

24. An enclosure system as in claim 23, wherein the first vertical leg further comprises a plurality of elongated openings for receiving screws for attaching the latch means to the first vertical leg such that the position of the latch means can be adjusted prior to fixedly attaching the latch means to the first vertical leg by way of said screws.

25. An enclosure system for electronic equipment concealable in a table top comprising:
(1) a saddle;
(2) a latch means;
(3) a plurality of spring means;
(4) a catch means;
(5) an enclosure suitable for housing electronic equipment and comprising a face plate, a top portion, two opposite side walls and a bottom portion;
(6) a top plate fixedly attached to the top portion of the enclosure;
(7) a bezel comprising a top surface and a bottom surface, the bezel defining an opening for receiving the top plate, wherein an outer perimeter of the bottom surface is for resting on edges of an opening cut through a table top;
(8) a hinge means;
wherein the saddle comprises:
a base member;
a first vertical leg extending up from one end of the base member and terminating in a first upper end;
a second vertical leg extending up from an opposite end of the base member and terminating in a second upper end, the first and second vertical legs and the base member together defining an open area for receiving the enclosure therein;
attachment means disposed on the first upper end and the second upper end fixedly attaching the saddle to the bottom surface of the bezel;
wherein the top plate is pivotally mounted to the bezel by way of the hinge means for pivotal movement of the enclosure from a concealed position in which the top plate is flush with the bezel to an open position in which the face plate is exposed;
wherein the latch means is fixedly attached to the first vertical leg and the catch means is fixedly attached to the bottom portion of the enclosure such that the latch means selectively maintains the enclosure in the concealed position by way of engaging with the catch means;
wherein each of the spring means is a substantially rectangular elongated plate made out of tempered carbon steel comprising a proximal end fixedly attached to the saddle and a distal end fixedly attached to the enclosure, biasing the enclosure towards the open position.

26. An enclosure system as in claim 25, wherein the hinge means further comprises dampening means preventing abrupt movement of the enclosure to the open position.

27. An enclosure system as in claim 26, wherein the saddle is formed from the material selected from the group consisting of bent sheet metal, machined metal, cast metal, bent wire and plastic.

28. An enclosure system as in claim 27, wherein the saddle further comprises a plurality of teeth disposed along outer edges of the first and second vertical legs, the teeth extending upwardly at a substantially forty five degree angle in relation to the outer edges and defining spaces therebetween for effecting insertion of holding plates, said holding plates being formed from strips of bent sheet metal and comprising openings for receiving lag screws for biasing the holding plates inserted in said spaces in the direction opposite to a bottom of the table top, thereby securing the saddle to the tabletop.

29. An enclosure system as in claim 28, wherein the catch means is a hook formed from the material selected from the group consisting of bent sheet metal, machined metal, cast metal, bent wire and plastic and wherein the latch means further comprises a spring loaded roller for engaging with the hook.

30. An enclosure system as in claim 29, wherein the first vertical leg further comprises a plurality of elongated openings for receiving screws for attaching the latch means to the first vertical leg such that the position of the latch means can be adjusted prior to fixedly attaching the latch means to the first vertical leg by way of said screws.

31. An enclosure system for electronic equipment concealable in a table top comprising:
(1) a saddle;
(2) a latch means;
(3) a spring means;
(4) a catch means;
(5) an enclosure suitable for housing electronic equipment and comprising a face plate, a top portion, two opposite side walls and a bottom portion;
(6) a top plate fixedly attached to the top portion of the enclosure;
(7) a bezel comprising a top surface and a bottom surface, the bezel defining an opening for receiving the top plate, wherein an outer perimeter of the bottom surface is for resting on edges of an opening cut through a table top;
(8) a hinge means;
wherein the saddle comprises:
a base member;
a first vertical leg extending up from one end of the base member and terminating in a first upper end;
a second vertical leg extending up from an opposite end of the base member and terminating in a second upper end, the first and second vertical legs and the base member together defining an open area for receiving the enclosure therein;
attachment means disposed on the first upper end and the second upper end fixedly attaching the saddle to the bottom surface of the bezel;
wherein the top plate is pivotally mounted to the bezel by way of the hinge means for pivotal movement of the enclosure from a concealed position in which the top plate is flush with the bezel to an open position in which the face plate is exposed;
wherein the latch means is fixedly attached to the first vertical leg and the catch means is fixedly attached to the bottom portion of the enclosure such that the latch means selectively maintains the enclosure in the concealed position by way of engaging with the catch means;
wherein the spring means is a plate made out of tempered carbon steel comprising a proximal end fixedly attached to the saddle and a distal end fixedly attached to the enclosure, biasing the enclosure towards the open positions the plate comprising sides tapered toward one another in the direction toward the distal end.

32. An enclosure system as in claim 31, wherein the hinge means further comprises dampening means preventing abrupt movement of the enclosure to the open position.

33. An enclosure system as in claim 32, wherein the saddle is formed from the material selected from the group consisting of bent sheet metal, machined metal, cast metal, bent wire and plastic.

34. An enclosure system as in claim 33, wherein the saddle further comprises a plurality of teeth disposed along outer edges of the first and second vertical legs, the teeth extending upwardly at a substantially forty five degree angle in relation to the outer edges and defining spaces therebetween for effecting insertion of holding plates, said holding plates being formed from strips of bent sheet metal and comprising openings for receiving lag screws for biasing the holding plates inserted in said spaces in the direction opposite to a bottom of the table top, thereby securing the saddle to the tabletop.

35. An enclosure system as in claim 34, wherein the catch means is a hook formed from the material selected from the group consisting of bent sheet metal, machined metal, cast metal, bent wire and plastic and wherein the latch means further comprises a spring loaded roller for engaging with the hook.

36. An enclosure system as in claim 35, wherein the first vertical leg further comprises a plurality of elongated openings for receiving screws for attaching the latch means to the first vertical leg such that the position of the latch means can be adjusted prior to fixedly attaching the latch means to the first vertical leg by way of said screws.
